(19) United States
(12) Patent Application Publication
(10) Pub. No.: US 2022/0207549 A1
(43) Pub. Date: Jun. 30, 2022

(54) INFORMATION PROCESSING APPARATUS, INFORMATION PROCESSING SYSTEM, INFORMATION PROCESSING METHOD, AND TERMINAL APPARATUS

(71) Applicant: TOYOTA JIDOSHA KABUSHIKI KAISHA, Toyota-shi (JP)

(72) Inventors: Toyokazu NAKASHIMA, Nagoya-shi (JP); Yurika TANAKA, Yokosuka-shi (JP); Shoji SAKAMOTO, Ichikawa-shi (JP); Yusuke KOBAYASHI, Ota-ku (JP); Kotaro OKABE, Ichikawa-shi (JP); Hirotada NAKANISHI, Toyota-shi (JP); Naoya OKA, Nagakute-shi (JP); Daiki OTANI, Nagoya-shi (JP)

(73) Assignee: TOYOTA JIDOSHA KABUSHIKI KAISHA, Toyota-shi (JP)

(21) Appl. No.: 17/560,431

(22) Filed: Dec. 23, 2021

(30) Foreign Application Priority Data
Dec. 28, 2020 (JP) 2020-219161

(51) Int. Cl. G06Q 30/02; G06Q 30/06

(52) U.S. Cl. CPC G06Q 30/0207; G06Q 30/0601

(57) ABSTRACT

An information processing apparatus includes a controller configured to: based on parked vehicle information related to a parked vehicle parked in a parking lot, detect whether there is a standby user waiting in or in the vicinity of the parked vehicle; and output, to a terminal apparatus, service information to be notified to the standby user.

### CROSS-REFERENCE TO RELATED APPLICATION

This application claims priority to Japanese Patent Application No. 2020-219161, filed on Dec. 28, 2020, the entire contents of which are incorporated herein by reference.

### TECHNICAL FIELD

The present disclosure relates to an information processing apparatus, an information processing system, an information processing method, and a terminal apparatus.

### BACKGROUND

Configurations for proposing a service to a user of a parking lot are known (for example, Patent Literature 1).

### CITATION LIST

### Patent Literature

PTL 1: JP 2018-032179 A

### SUMMARY

Improved convenience for a user waiting in a parked vehicle is desired.

It would be helpful to improve the convenience for a user waiting in a parked vehicle.

An information processing apparatus according to an embodiment of the present disclosure includes a controller configured to: based on parked vehicle information related to a parked vehicle parked in a parking lot, detect whether there is a standby user waiting in or in the vicinity of the parked vehicle; and output, to a terminal apparatus, service information to be notified to the standby user.

An information processing system according to an embodiment of the present disclosure includes the information processing apparatus and the terminal apparatus.

An information processing method according to an embodiment of the present disclosure includes: acquiring parked vehicle information related to a parked vehicle parked in a parking lot; detecting whether there is a standby user waiting in or in the vicinity of the parked vehicle based on the parked vehicle information; and outputting, to a terminal apparatus, service information to be notified to the standby user.

A terminal apparatus according to an embodiment of the present disclosure includes an output interface and a controller. The output interface outputs information to a standby user waiting in or in the vicinity of a parked vehicle parked in a parking lot. The controller is configured to communicate with an information processing apparatus, and the controller acquires, from the information processing apparatus, service information to be notified to the standby user and causes the output interface to output the service information.

According to the information processing apparatus, the information processing system, the information processing method, and the terminal apparatus of an embodiment of the present disclosure, convenience can be improved for a user waiting in a parked vehicle.

### BRIEF DESCRIPTION OF THE DRAWINGS

In the accompanying drawings:

FIG. 1 is a schematic diagram illustrating an example configuration of an information processing system according to an embodiment;

FIG. 2 is a block diagram illustrating an example configuration of the information processing system according to the embodiment;

FIG. 3 is a block diagram illustrating an example configuration of a terminal apparatus;

FIG. 4 is a flowchart illustrating an example procedure for an information processing method according to an embodiment; and

FIG. 5 is a flowchart illustrating an example procedure for a terminal control method according to an embodiment.

### DETAILED DESCRIPTION

### Example Configuration of Information Processing System 1

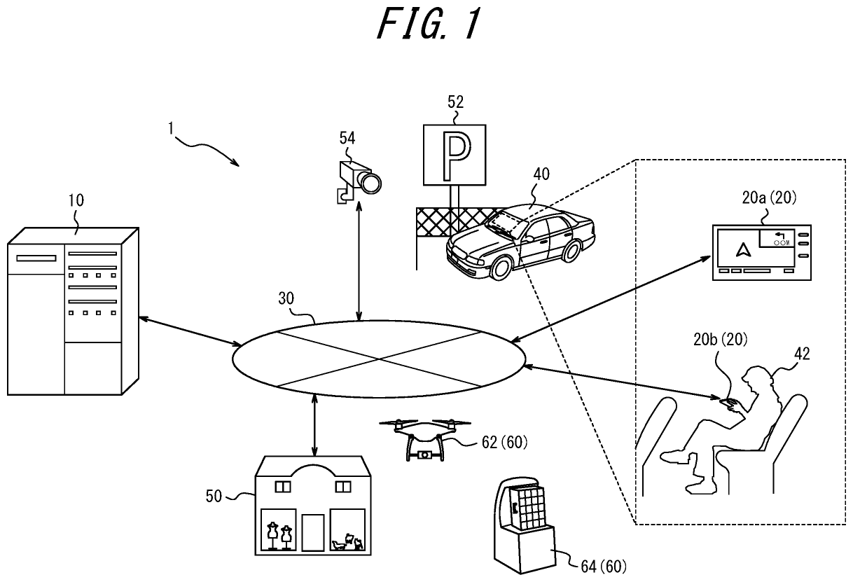

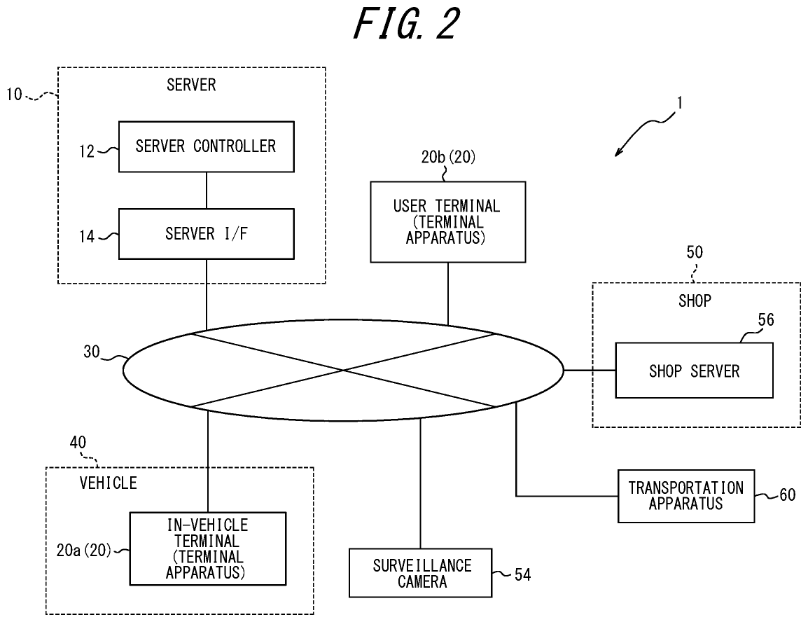

As illustrated in FIG. 1 and FIG. 2, an information processing system 1 according to an embodiment includes a server 10 and terminal apparatuses 20.

In the information processing system 1 according to the present embodiment, the server 10 generates and outputs information related to a service that can be provided to a user 42 who is waiting in or in the vicinity of a vehicle 40 parked in a parking lot 52. The vehicle 40 parked in the parking lot 52 is also referred to as a parked vehicle. The user 42 waiting in or in the vicinity of the parked vehicle is also referred to as a standby user. The information processing system 1 provides service information to the standby user waiting in or in the vicinity of the parked vehicle. The standby user waiting in the vicinity of the parked vehicle includes the user 42 who is temporarily outside the parked vehicle so as to, for example, smoke or talk on the phone.

For example, a standby user can be identified from the situation described below. A user 42 parks the vehicle 40 in the parking lot 52 and uses a shop 50 or the like that the user 42 can go on foot or by other means than the vehicle 40 from the parking lot 52. In a case in which a plurality of users 42 is on board the vehicle 40, while some of the users 42 are using the shop 50 after getting out of the parked vehicle, the remaining users 42 in the vehicle 40 may wait in or in the vicinity of the parked vehicle. In this case, the users 42 waiting in or in the vicinity of the vehicle 40 fall into the category of a standby user. The standby users may include a driver who has driven the vehicle 40 to the parking lot 52, or may include persons who have ridden on the vehicle 40 without driving the vehicle 40.

<Server 10>

The server 10 includes a server controller 12 and a server interface 14. The server interface 14 is also referred to as a server I/F 14.

The server controller 12 controls the components of the server 10. The server controller 12 is also referred to simply as a controller. The server controller 12 may configured with at least one processor. The “processor” is a general purpose processor, a dedicated processor that is dedicated to specific processing, or the like in the present embodiment, but is not limited to these. The server controller 12 may be configured with at least one dedicated circuit. Examples of dedicated circuits may include a field-programmable gate array (FPGA) and an application specific integrated circuit (ASIC). The server controller 12 may be configured with the dedicated circuit instead of the processor, or may be configured with the dedicated circuit along with the processor.

The server 10 may further include a memory. The memory may be, but is not limited to, a semiconductor memory, a magnetic memory, or an optical memory. The memory may function, for example, as a main memory, an auxiliary memory, or a cache memory. The memory may include an electromagnetic storage medium, such as a magnetic disk. The memory may include a non-transitory computer readable medium. The memory may store any information used for the operations of the server 10. For example, the memory may store a system program, an application program, or the like. The memory may be included in the server controller 12.

Information, data, or the like is outputted from and inputted to the server controller 12, through the server I/F 14. The server I/F 14 is also referred to simply as an interface or I/F.

The server I/F 14 may include a communication module for communication to other apparatuses, such as the terminal apparatuses 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The server I/F 14 may be configured to be connected to the communication module.

The server 10 may include a single server apparatus, or multiple server apparatuses capable of communicating with each other. The server 10 is also referred to as an information processing apparatus.

<Terminal Apparatus 20>

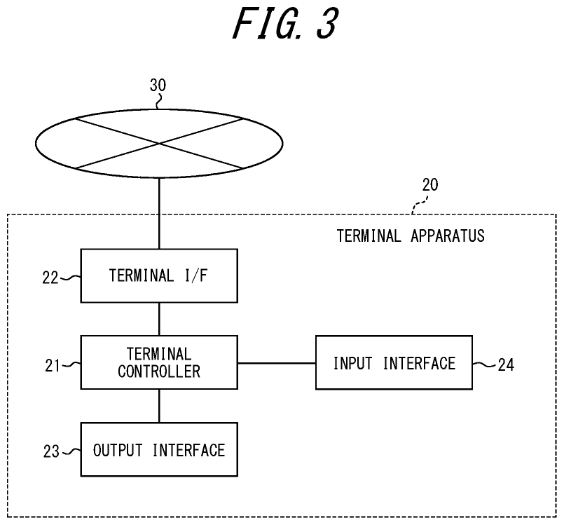

As illustrated in FIG. 3, each terminal apparatus 20 includes a terminal controller 21 and a terminal interface 22. The terminal interface 22 is also referred to as a terminal I/F 22.

The terminal controller 21 controls the components of the terminal apparatus 20. The terminal controller 21 is also referred to simply as a controller. The terminal controller 21 may be configured to be identical or similar to the server controller 12 of the server 10. The terminal controller 21 may configured with at least one processor. The terminal controller 21 may be configured with at least one dedicated circuit. Examples of dedicated circuits may include an FPGA and an ASIC. The terminal controller 21 may be configured with the dedicated circuit instead of the processor, or may be configured with the dedicated circuit along with the processor.

The terminal apparatus 20 may further include a memory. The memory of the terminal apparatus 20 may be configured to be identical or similar to the memory of the server 10. The memory may be, but is not limited to, a semiconductor memory, a magnetic memory, an optical memory, or the like, for example. The memory may function, for example, as a main memory, an auxiliary memory, or a cache memory. The memory may include an electromagnetic storage medium, such as a magnetic disk. The memory stores any information used for operation of the terminal apparatus 20. For example, the memory may store a system program, an application program, or the like. The memory may be included in the terminal controller 21.

Information, data, or the like is outputted from and inputted to the terminal controller 21, through the terminal I/F 22. The terminal I/F 22 is also referred to simply as an interface or I/F.

The terminal I/F 22 may be configured to be identical or similar to the server I/F 14. The terminal I/F 22 may include a communication module for communication to other apparatuses, such as the server 10, via the network 30. The communication module may include, but is not limited to, a communication module compliant with a mobile communication standard, such as the 4th Generation (4G) standard or the 5th Generation (5G) standard. The terminal I/F 22 may be configured to be connected to the communication module.

The terminal apparatus 20 further includes an input interface 24. The input interface 24 may be configured with an input device for receiving inputs, such as information or data, from the user 42. The input device may be configured with, for example, a touch panel, a touch sensor, or a pointing device such as a mouse. The input device may be configured with a physical key. The input device may be configured with an audio input device, such as a microphone.

The input interface 24 may be configured to acquire positional information for the terminal apparatus 20 itself or the user 42. The input interface 24 may include a receiver compliant with a satellite positioning system. The receiver compliant with the satellite positioning system may include, for example, a Global Positioning System (GPS) receiver.

The input interface 24 may include a camera. The input interface 24 may acquire information related to the user 42 who is around by capturing an image of the surroundings using the camera. In a case in which the terminal apparatus 20 is mounted to the vehicle 40, the input interface 24 may acquire information related to the user 42 who is on board the vehicle 40.

The input interface 24 may output the acquired information to the server 10 via the terminal I/F 22. The terminal controller 21 may cause the information acquired through the input interface 24 to be outputted through the terminal I/F 22.

The terminal apparatus 20 further includes an output interface 23. The output interface 23 is configured with an output device that outputs information, data, or the like to the user 42. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices.

The output interface 23 may output information that is acquired from the server 10 via the terminal I/F 22. The terminal controller 21 may cause the output interface 23 to output the information acquired through the terminal I/F 22.

The number of terminal apparatuses 20 included in the information processing system 1 is not limited to one and may be two or more. The terminal apparatuses 20 may include an in-vehicle terminal 20a that is mounted to the vehicle 40. The in-vehicle terminal 20a may be configured as a car navigation device that provides a navigation function of the vehicle 40. The terminal apparatuses 20 may include a user terminal 20B that is in the possession of the user 42. The user terminal 20b may include a mobile terminal, such as a smartphone or a tablet, or a Personal Computer (PC), such as a notebook PC or a tablet PC. The terminal apparatuses 20 are not limited to the above examples and may include various devices.

The user terminal 20b of the user 42 may be associated with the vehicle 40 boarded by the user 42. The user terminal 20b of the user 42 may be associated with the in-vehicle terminal 20a mounted to the vehicle 40 boarded by the user 42.

<Configuration Related to Shop 50 and Parking Lot 52>

As illustrated in FIG. 1 and FIG. 2, the information processing system 1 further includes a surveillance camera 54, although this is not essential. The surveillance camera 54 captures an image of the vehicle 40 parked in the parking lot 52 and outputs the captured image to the server 10. The information processing system 1 further includes a shop server 56 that is installed in the shop 50, although this is not essential. The shop server 56 may be configured to be identical or similar to the server 10. The information processing system 1 further includes transportation apparatuses 60, although this is not essential. As described later, a standby user can purchase products while waiting in or in the vicinity of a parked vehicle. The transportation apparatuses 60 are configured to deliver products to the parked vehicle. The transportation apparatuses 60 may include a variety of apparatuses, such as a drone 62 or a transfer robot 64.

The shop 50 may be located adjacent to the parking lot 52 or within a predetermined distance from the parking lot 52. The shop 50 may be located such that the user 42 may visit there, for example, on foot or by shuttle bus from the parking lot 52. The shop 50 may provide a service of delivering products to the parking lot 52. The shop 50 may be configured to be used by the user 42 who has parked the vehicle 40 in the parking lot 52. The shop 50 that can be used by the user 42 who has parked the vehicle 40 in the parking lot 52 may be associated with the parking lot 52. The shop 50 that is associated with the parking lot 52 is also referred to as a related shop. The related shop may include the shop 50 regardless of whether the user 42 can visit the shop 50 while the vehicle 40 is parked in the parking lot 52 or cannot visit the shop 50.

### Operation Example of Information Processing System 1

The information processing system 1 according to the present embodiment notifies a standby user waiting in or in the vicinity of a parked vehicle of service information. The service information contains information related to a service that can be used by the standby user. In the following, an example of the operations executed by the server 10 and the terminal apparatuses 20 of the information processing system 1 to notify a standby user of service information is described.

<Detection of Parked Vehicle and Standby User>

The server controller 12 acquires information related to a parked vehicle so as to detect a standby user waiting in or in the vicinity of the parked vehicle. Information related to a parked vehicle is also referred to as parked vehicle information. The server controller 12 detects a standby user waiting in or in the vicinity of a parked vehicle based on parked vehicle information.

The server controller 12 detects a parked vehicle. For example, the server controller 12 may acquire an image of the parking lot 52 captured by the surveillance camera 54 as parked vehicle information. Based on the acquired image, the server controller 12 may detect a vehicle 40 which is parked in the parking lot 52 as the parked vehicle. Further, the server controller 12 may judge whether a vehicle 40 is parked in the parking lot 52, based on positional information for an in-vehicle terminal 20a mounted to the vehicle 40. When a vehicle 40 is parked in the parking lot 52, the server controller 12 may detect the vehicle 40 as the parked vehicle.

The server controller 12 detects a standby user waiting in or in the vicinity of the parked vehicle based on parked vehicle information. For example, the server controller 12 may acquire an image of the parked vehicle captured by the surveillance camera 54 as the parked vehicle information. Based on the acquired image, the server controller 12 may detect a user 42 who is in or in the vicinity of the parked vehicle as the standby user.

The server controller 12 may acquire information outputted by the in-vehicle terminal 20a mounted to the vehicle 40 that has been detected as the parked vehicle as parked vehicle information. The server controller 12 may acquire an image of the inside of the parked vehicle from the in-vehicle terminal 20a and detect a user 42 who is in the parked vehicle as the standby user based on the image.

The server controller 12 may acquire information outputted by the vehicle 40 that has been detected as the parked vehicle or by a user terminal 20b associated with the in-vehicle terminal 20a mounted to the parked vehicle as parked vehicle information. The server controller 12 may acquire positional information for the user 42 from the user terminal 20b and detect the user 42 as the standby user when it is judged that the user 42 remains in or in the vicinity of the parked vehicle based on the positional information for the user 42.

In a case in which the user terminal 20b in the possession of the user 42 is associated with the vehicle 40 or with the in-vehicle terminal 20a mounted to the vehicle 40, the server controller 12 may acquire positional information for the user 42 from the user terminal 20b as parked vehicle information. The server controller 12 may judge that the user 42 falls into the category of a standby user when it is judged that the user 42 is in the parking lot 52 based on the positional information for the user 42. That is, the server controller 12 may detect whether there is a standby user based on the positional information for the user 42 acquired from the user terminal 20b. The server controller 12 may judge that the user 42 falls into the category of a standby user when it is judged that the vehicle 40 is parked in the parking lot 52 based on positional information for the in-vehicle terminal 20a mounted to the vehicle 40 of the user 42 or the user terminal 20b. That is, the server controller 12 may detect whether there is a standby user further based on the positional information for the in-vehicle terminal 20a mounted to the vehicle 40 of the user 42 or the user terminal 20b.

The server controller 12 may detect a user 42 who remains in or in the vicinity of the parked vehicle for a predetermined time or longer as the standby user. The server controller 12 may detect a user 42 who remains within a predetermined distance from the parked vehicle as the standby user.

<Output of Service Information>

When a standby user waiting in or in the vicinity of a parked vehicle is detected, the server controller 12 generates service information to be provided to the standby user, and outputs the service information to the terminal apparatus 20.

<<Information Related to Shop 50>>

The server controller 12 may output information related to a shop 50 that can be used by the standby user as the service information. The shop 50 that can be used by the standby user is also referred to as an accessible shop.

The server controller 12 may output, for example, information related to the types or prices of products sold at the accessible shop, as the information related to the accessible shop. The server controller 12 may output information related to the types or prices of services provided at the accessible shop, as the information related to the accessible shop.

The server controller 12 may output information related to an incentive to be granted when, for example, the standby user visits the accessible shop, as the information related to the accessible shop. The operations of the server controller 12 to grant the incentive to the standby user will be described later.

<<Information Related to Purchase of Products>>

The server controller 12 may output information for the standby user to purchase products as the service information. The information for the standby user to purchase products is also referred to as purchase information. As the purchase information, the server controller 12 may output information that provides a means for the standby user to purchase or order products while waiting in or in the vicinity of the parked vehicle.

It is assumed that a shop 50 associated with the parking lot 52 accepts a purchase or order request from the standby user in the information processing system 1. The shop 50 associated with the parking lot 52 is also referred to as a related shop. The related shop may include at least part of an accessible shop or may include the shop 50 that is not an accessible shop.

The server controller 12 may output, for example, a Uniform Resource Locator (URL) to access a shopping site, a coupon site, or the like from the terminal apparatus 20, as the purchase information. The server controller 12 may output information related to a discount for products that can be purchased by the standby user, as the purchase information. The server controller 12 may output information on a coupon that can be used by the standby user when they purchase products, as the purchase information.

The server controller 12 may output information for the standby user to purchase products sold at the related shop, as the purchase information. The server controller 12 may acquire, from the shop server 56 of the related shop, the purchase information to be outputted to the terminal apparatus 20.

The server controller 12 may output information on products that can be delivered to the parking lot 52, as the purchase information. The products that can be delivered to the parking lot 52 are also referred to as delivery products.

<Use of Service by Standby User>

The terminal controller 21 of the terminal apparatus 20 acquires service information from the server 10 via the terminal I/F 22. The terminal controller 21 causes the output interface 23 to output the service information to thereby notify the standby user. The standby user may use a service based on the notified service information.

The standby user may visit an accessible shop, purchase products at the accessible shop, or receive provision of a service from the accessible shop based on information on the accessible shop notified as the service information. When the standby user has visited the accessible shop and used the service, the shop server 56 of the accessible shop or the user terminal 20b of the standby user may output, to the server 10, information indicating that the standby user has used the service at the accessible shop. The server controller 12 may grant an incentive to the standby user when the standby user has used the service at the accessible shop.

The standby user may request purchase of a product or order a product based on purchase information notified as the service information. Specifically, the standby user can request purchase of a product or order a product by inputting information to the terminal apparatus 20. When the standby user requests purchase of a product or orders a product based on the purchase information, the terminal controller 21 of the terminal apparatus 20 accepts an input indicating the purchase or order from the standby user through the input interface 24. In a case in which a product requested by the standby user is a delivery product, the terminal controller 21 may also accept an input related to a preference for delivery of the product through the input interface 24. The terminal controller 21 outputs the information inputted by the standby user to the server 10 via the terminal I/F 22. The information related to a purchase or order request inputted by the standby user for the product is also referred to as request information.

Upon acquiring the request information from the standby user from the terminal apparatus 20, the server controller 12 may output, to the shop server 56 of the related shop, information on a product for which purchase has been requested or information on a product that has been ordered. The server controller 12 may output the request information from the standby user itself to the shop server 56 of the related shop. The information related to purchase or order of a product that is outputted from the server controller 12 to the shop server 56 is also referred to as order placement information. The shop server 56 may notify a clerk in the related shop of the order placement information and cause the clerk to provide the product to the standby user.

In a case in which the product that the standby user has requested to purchase or ordered is a delivery product, the shop server 56 may notify the clerk of the related shop so that the delivery product can be delivered to the parked vehicle.

The shop server 56 may cause the transportation apparatus 60 to deliver the product from the related shop to the parked vehicle. The shop server 56 may output control information to the transportation apparatus 60 so as to cause the transportation apparatus 60 to store the delivery product in the parked vehicle. The transportation apparatus 60 may be configured to request the standby user to open the door of the parked vehicle in order to store the delivery product in the parked vehicle. The transportation apparatus 60 may be configured to cause the parked vehicle to unlock and open the door. The transportation apparatus 60 may be configured to unlock and open the door of the parked vehicle.

When the standby user requests purchase of a product, the information processing system 1 may accept the request after the payment for the product is settled. For example, when accepting an input indicating a purchase request from the standby user for a product, the terminal controller 21 may acquire various payment information, such as credit card information, or barcode or QR Code® (QR code is a registered trademark in Japan, other countries, or both) payment information, as payment information for the price of the product.

When the standby user orders a product, the information processing system 1 may accept the order after payment for the product is settled. The information processing system 1 may also allow payment for the product to be settled in exchange for delivery of the product. In a case in which payment for the product is settled in exchange for delivery of the product, the payment may be received by a clerk in the related shop or by the transportation apparatus 60.

The server controller 12 may grant an incentive to the standby user when the standby user purchases a product from the related shop.

<Granting of Incentive>

The server controller 12 may output information to grant an incentive to the user terminal 20b of the standby user or to the in-vehicle terminal 20a of the vehicle 40 in which the standby user was waiting, when the standby user satisfies a condition for the incentive to be granted. The condition for the incentive to be granted is also referred to as a granting condition. The granting condition may include, for example, that the standby user visits the related shop. The granting condition may include that the standby user purchases a product or receives provision of a service upon payment of a fee at the related shop.

The server controller 12 may acquire information that the standby user has visited the related shop or purchased a product at the related shop from the user terminal 20b of the standby user. The server controller 12 may acquire the information that the standby user has visited the related shop or purchased the product at the related shop from the shop server 56 of the related shop.

As the incentive, the server controller 12 may grant points, for example. As the incentive, the server controller 12 may grant points that can be exchanged for valuables or a paid service provided at the related shop or another shop 50. As the incentive, the server controller 12 may grant electronic money.

The server controller 12 may determine the incentive to be granted to the standby user in accordance with the state of congestion of the accessible shop. The server controller 12 may increase the incentive granted to the standby user when they visits the accessible shop if, for example, the number of persons visiting the accessible shop is less than a predetermined number or the population density in the accessible shop is less than a predetermined value. Conversely, the server controller 12 may reduce the incentive granted to the standby user when they visits the accessible shop if, for example, the number of persons visiting the accessible shop is more than or equal to the predetermined number or the population density in the accessible shop is more than or equal to the predetermined value.

The server controller 12 may determine the incentive to be granted to the standby user in accordance with the state of congestion of the related shop. For example, the server controller 12 may increase the incentive granted to the standby user who wants to collect a delivery product at the related shop, if the number of requests received at the related shop is more than or equal to a predetermined number. Conversely, the server controller 12 may reduce the incentive granted to the standby user when they want delivery of a delivery product.

### Example Procedure for Information Processing Method

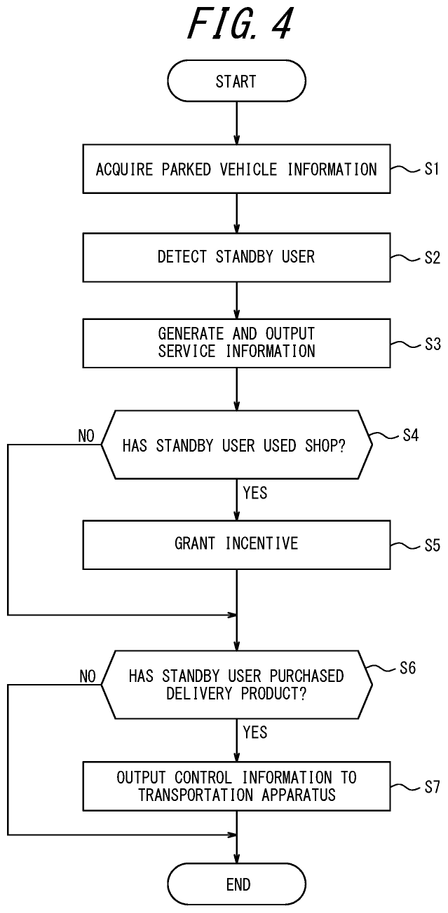

As described above, the information processing system 1 according to the present embodiment can notify a standby user of service information and allow the standby user to use the service. The terminal controller 12 of the server 10 may execute an information processing method including, for example, a procedure shown in the flowchart illustrated in FIG. 4. The server controller 12 can generate and output information to be notified to the standby user in a parked vehicle by executing the illustrated information processing method. The information processing method may be implemented as an information processing program to be executed by the server controller 12.

The server controller 12 acquires parked vehicle information (Step S1). The server controller 12 detects a standby user based on the parked vehicle information (Step S2). The server controller 12 generates service information to be notified to the detected standby user and outputs the service information to the terminal apparatus 20 (Step S3).

The server controller 12 judges whether the standby user has used a shop 50 (Step S4). Specifically, the server controller 12 may judge that the standby user has used the shop 50 when the standby user has visited an accessible shop or purchased a product at the accessible shop. If the standby user has used the shop 50 (Step S4: YES), the server controller 12 grants an incentive to the standby user (Step S5). After performing the procedure of step S5, the server controller 12 proceeds to the procedure of step S6. If the standby user has not used the shop 50 (Step S4: NO), the server controller 12 proceeds to the procedure of Step S6.

The server controller 12 judges whether the standby user has purchased a delivery product (Step S6). If the standby user has purchased a delivery product (Step S6: YES), the server controller 12 outputs control information to cause the transportation apparatus 60 to deliver the delivery product (Step S7). After executing the procedure of Step S7, the server controller 12 ends the execution of the procedure shown in the flowchart of FIG. 4. If the standby user has not purchased a delivery product (Step S6: NO), the server controller 12 ends the execution of the procedure in the flowchart of FIG. 4.

In the procedure of Step S7, instead of the server controller 12 outputting the control information to the transportation apparatus 60, the shop server 56 may output control information to the transportation apparatus 60.

### Example Procedure for Terminal Control Method

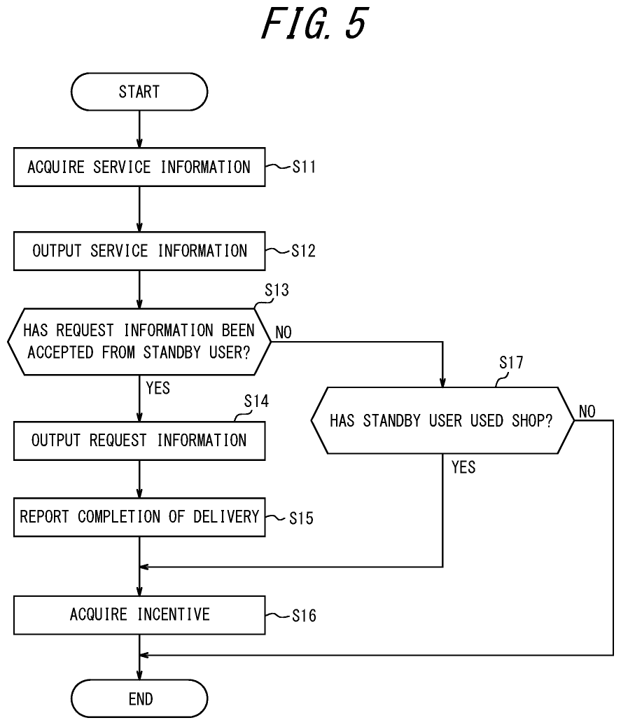

The terminal controller 21 of the terminal apparatus 20 may execute a terminal control method including, for example, a procedure shown in the flowchart illustrated in FIG. 5. The terminal controller 21 can notify information to the standby user in the parked vehicle by executing the illustrated terminal control method. The terminal control method may be implemented as a terminal control program to be executed by the terminal controller 21.

The terminal controller 21 acquires service information from the server 10 (Step S11). The terminal controller 21 causes the output interface 23 to output the service information (Step S12).

The terminal controller 21 judges whether an input indicating request information has been accepted from the standby user (Step S13). If it is judged that an input indicating request information has not been accepted from the standby user (Step S13: NO), the terminal controller 21 proceeds to the procedure of Step S17.

If it is judged that an input indicating request information has been accepted from the standby user (Step S13: YES), the terminal controller 21 outputs the request information to the server 10 (Step S14). Here, it is assumed that the request information includes information that the standby user wants to purchase a delivery product and have it delivered. It is assumed that the server 10, upon acquiring the request information, causes the transportation apparatus 60 or a clerk in the related shop to deliver the delivery product. The terminal controller 21 reports to the server 10 that the delivery product has been delivered (Step S15). The terminal controller 21 acquires information for granting an incentive that is outputted from the server 10 (Step S16). After executing the procedure of Step S16, the terminal controller 21 ends the procedure of the flowchart in FIG. 5.

If it is judged that an input indicating request information has not been accepted from the standby user (Step S13: NO), the terminal controller 21 judges whether the standby user has used the shop 50 (Step S17). If it is judged that the standby user has not used the shop 50 (Step S17: NO), the terminal controller 21 ends the procedure of the flowchart in FIG. 5. If it is judged that the standby user has used the shop 50 (Step S17: YES), the terminal controller 21 acquires the information for granting the incentive (Step S16) and ends the execution of the procedure of the flowchart in FIG. 5.

### SUMMARY

As described above, the information processing system 1 can notify service information to a standby user waiting in or in the vicinity of a parked vehicle and allow the standby user to use the service. Further, the information processing system 1 allows a standby user to purchase products while waiting in or in the vicinity of a parked vehicle. Consequently, the convenience for a standby user is improved. Moreover, the information processing system 1 can encourage a standby user to use a service. Consequently, a shop 50, such as an accessible shop or a related shop, can attract more customers.

### Other Embodiments

The server controller 12 may grant authorization only to a standby user to view service information. Specifically, the server controller 12 may output a URL that identifies a site that can be accessed only by the standby user, as the service information. Further, the server controller 12 may output a URL that identifies a site that can be accessed by the user 42 only while they fall into the category of a standby user, as the service information. This can encourage the standby user to use the service.

The server controller 12 may generate service information based on information related to a standby user. The information related to the standby user may include, for example, attribute information, such as the age group or gender, of the standby user. The server controller 12 may acquire the information related to the standby user from the in-vehicle terminal 20a mounted to the parked vehicle. The server controller 12 may acquire the information related to the standby user from the user terminal 20b in the possession of the standby user. By the service information being generated based on the information related to the standby user, the standby user is more likely to use the service.

The information processing system 1 may allow a standby user to receive a product that the standby user has requested to purchase or ordered based on purchase information when the standby user is waiting at the parking lot 52 or after the standby user has left the parking lot 52 by vehicle 40. For example, the product that the standby user has requested to purchase or ordered based on the purchase information may be delivered to a location designated by the standby user, such as the home of the standby user.

The parking lot 52 may include various types of parking lots, such as a coin-operated parking, a parking space where parking duration is managed by a parking meter, or a parking space at a traffic circle in front of a station.

The server 10 may include different server apparatuses for different operations. For example, the server 10 may include a server apparatus that detects a standby user and a server apparatus that generates and outputs service information, as separate apparatuses.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising a controller configured to:
based on parked vehicle information related to a parked vehicle parked in a parking lot, detect whether there is a standby user waiting in or in the vicinity of the parked vehicle; and
output, to a terminal apparatus, service information to be notified to the standby user.

2. The information processing apparatus according to claim 1, wherein the controller is configured to output information on a shop that can be used by the standby user, as the service information.

3. The information processing apparatus according to claim 2, wherein the controller is configured to output, to the terminal apparatus, information related to an incentive to be granted when the standby user visits the shop that can be used.

4. The information processing apparatus according to claim 3, wherein the controller is configured to determine the incentive in accordance with a state of congestion of the shop that can be used.

5. The information processing apparatus according to claim 1, wherein the controller is configured to output purchase information for the standby user to purchase products while waiting in the parked vehicle, as the service information.

6. The information processing apparatus according to claim 5, wherein the controller is configured to output information related to a discount for products or information on a coupon that can be used for purchasing products, as the purchase information.

7. The information processing apparatus according to claim 5, wherein the controller is configured to output information on products that are sold at a related shop associated with the parking lot, as the purchase information.

8. The information processing apparatus according to claim 5, wherein the controller is configured to output information on a delivery product that can be delivered to the parking lot, as the purchase information.

9. The information processing apparatus according to claim 8, wherein, when the standby user purchases the delivery product, the controller outputs control information to a transportation apparatus configured to deliver the delivery product so as to cause the transportation apparatus to deliver the delivery product to the parked vehicle.

10. The information processing apparatus according to claim 9, wherein the controller is configured to output control information to the transportation apparatus so as to cause the transportation apparatus to store the delivery product in the parked vehicle.

11. The information processing apparatus according to claim 5, wherein the controller is configured to output, to the terminal apparatus, information related to an incentive to be granted when the standby user purchases a product based on the purchase information.

12. The information processing apparatus according to claim 1, wherein the controller is configured to grant authorization to the standby user to view the service information.

13. The information processing apparatus according to claim 1, wherein the controller is configured to detect whether there is a standby user based on an image of the parked vehicle acquired as the parked vehicle information.

14. The information processing apparatus according to claim 1, wherein the controller is configured to detect whether there is a standby user based on positional information for the terminal apparatus.

15. An information processing system comprising:
the information processing apparatus according to claim 1; and
the terminal apparatus.

16. An information processing method comprising:
acquiring parked vehicle information related to a parked vehicle parked in a parking lot;
detecting whether there is a standby user waiting in or in the vicinity of the parked vehicle based on the parked vehicle information; and
outputting, to a terminal apparatus, service information to be notified to the standby user.

17. The information processing method according to claim 16, wherein the outputting of the service information includes outputting information on a related shop that can be used by the standby user, as the service information.

18. The information processing method according to claim 16, wherein the outputting of the service information includes outputting purchase information for the standby user to purchase products while waiting in or in the vicinity of the parked vehicle, as the service information.

19. A terminal apparatus comprising:
an output interface configured to output information to a standby user waiting in or in the vicinity of a parked vehicle parked in a parking lot; and
a controller configured to communicate with an information processing apparatus and configured to acquire, from the information processing apparatus, service information to be notified to the standby user and cause the output interface to output the service information.

20. The terminal apparatus according to claim 19, further comprising an input interface configured to accept an input from the standby user, wherein the controller is configured to acquire an input from the standby user requesting purchase of a product based on the service information through the input interface and produce an output to the information processing apparatus.
